(19) United States
(12) Patent Application Publication
(10) Pub. No.: US 2007/0064677 A1
(43) Pub. Date: Mar. 22, 2007

(54) Packet media gateway with a secondary PSTN connection and method for time slot switching

(75) Inventor: Ying Xiong, San Jose, CA (US)

Correspondence Address: TIMOTHY P. O'HAGAN, 8710 KILKENNY CT, FORT MYERS, FL, 33912, US

(73) Assignee: Innomedia Pte Ltd., The Alpha (SG)

(21) Appl. No.: 11/222,924

(22) Filed: Sep. 12, 2005

(51) Int. Cl. H04L 12/66

(52) U.S. Cl. 370/352

(57) ABSTRACT

A media gateway for coupling to both an Internet service provider frame switched network and a PSTN provider circuit switched network comprises an FXS port to which a telephony device may be coupled to initiate a connection to a destination. A programmable DSP includes a time-division multiplexing bus coupled to the FXS port and a PSTN port which couples to a subscriber loop of the circuit switched network. Compression instruction code is programmed into the digital signal processor in response to determining that the connection to the destination is to be established using a real time communication channel over the frame switched network. Time slot switching instruction code is programmed into the digital signal processor in response to determining that the connection to the destination is to be established over the circuit switched network. The time slot switching instruction code provides for: i) buffering digital audio data received from the FXS port during an occurrence of a periodic time slot assigned to the FXS port and transferring such digital audio data to the PSTN port during an occurrence of a periodic time slot assigned to the PSTN port; and ii) buffering digital audio data received from the PSTN port during an occurrence of the periodic time slot assigned to the PSTN port and transferring such digital audio data to the FXS port during an occurrence of the periodic time slot assigned to the FXS port.

### TECHNICAL FIELD

The present invention relates to a packet media gateway with a secondary PSTN connection and more specifically, to a system for programming a digital signal processor to selectively perform media compression to support a real time media channel over a frame switched network and time slot switching to support a circuit switched connection over the public switched telephone network.

### BACKGROUND OF THE INVENTION

For many years voice telephone service was implemented over a circuit switched network commonly known as the public switched telephone network (PSTN) and controlled by a local telephone service provider. In such systems, the analog electrical signals representing the conversation are transmitted between the two telephone handsets on a dedicated twisted-pair-copper-wire circuit. More specifically, each telephone handset is coupled to a local switching station on a dedicated pair of copper wires known as a subscriber loop. When a telephone call is placed, the circuit is completed by dynamically coupling each subscriber loop to a dedicated pair of copper wires between the two switching stations.

Recently, digital interfaces with the PSTN have been developed. Digital subscriber loop technology enables several subscriber loops to be implemented over a two to four wire set or even alternative media such as fiber optics.

More recently yet voice telephone service has been implemented over the Internet. Advances in the speed of Internet data transmissions and Internet bandwidth have made it possible for telephone conversations to be communicated using the Internet's packet switched architecture.

One problem is that Internet service is not yet as reliable as analog or digital PSTN telephone service. When an Internet connection is unavailable, a telephony service provided over the Internet is likewise unavailable. Further, the Internet comprises various transmission lines interconnected with routers. When Internet traffic load is high, frames can be significantly delayed in router buffers or even dropped when router buffers “overflow”. Frame delays and dropped frames significantly degrade audio quality of services (QOS)—well below audio QOS provided by the PSTN.

This problem has lead to the development of packet media gateways with secondary, or back up, PSTN connections. A packet media gateway generally refers to a device with a plurality of FXS ports into which a user plugs his or her telephones, fax machines, and other FXO devices. The gateway includes systems for establishing real time media sessions with remote VoIP systems for interfacing between digital audio exchanged with the FXS port and frames of compressed digital audio data exchanged with the remote VoIP system over the Internet. A back up PSTN connection is one or more ports which couple to a subscriber loop of the PSTN and enable calls to be placed over the PSTN when Internet service is unavailable.

A problem associated with PTSN back up is its added cost. Referring briefly to FIG. 1, a gateway 10 with a backup connection to the PSTN 12 includes PSTN ports 14 for coupling to PSTN subscriber loops. Each of a plurality of FXS ports 16 connects to an FXO device 18 such as a traditional PSTN telephone or a fax machine. An audio DSP 20 interfaces between digital audio exchanged with the FXS port and frames of compressed digital audio data which are encapsulated in IP frames for exchange over the Internet. If PSTN backup and PSTN ports were not used, the FXS ports 16 could connect directly to audio DSP (typically using a Time Division Multiplexing (TDM) bus). However, because PSTN back-up is included a switch circuit 22 is used for selectively coupling each FXS port 16 to either: i) the audio DSP 20 for Internet telephony service or ii) a PSTN port for PSTN telephony service. The switch circuit 22 adds cost to the device.

What is needed is a packet media gateway with a secondary or back up PSTN connection that does not suffer the disadvantages of known systems.

### SUMMARY OF THE INVENTION

In a first aspect, the present invention comprises a media gateway for coupling to an Internet service provider frame switched network. The media gateway further includes a secondary PSTN connection for coupling to a circuit switched network such as the PSTN.

The media gateway comprises a programmable digital signal processor (DSP), a first FXS port, and a first PSTN port. The first FXS port couples to the DSP and is configured to exchange digital audio data with the DSP during a first periodic time-division multiplexing (TDM) bus time slot. The first PSTN port couples to the DSP and is configured to exchange data with the DSP during a second periodic TDM bus time slot.

A control system manages programming of the DSP. The control system programs first time slot switching instruction code into the DSP if a media session is to be connected to a destination over the PSTN. The first time slot switching instruction code: i) buffers digital audio data received from the first FXS port during an occurrence of the first periodic time slot and transfers such digital audio data to the first PSTN port during an occurrence of the second periodic time slot; and ii) buffers digital audio data received from the first PSTN port during an occurrence of the second periodic time slot and transfers such digital audio data to the first FXS port during an occurrence of the first periodic time slot. Each of the first periodic time slot and the second periodic time slot periodically occur during mutually exclusive periods of time and are of equal duration of time.

The control system programs first compression/decompression instruction code into the DSP if a media session is to be connected to a destination over the frame switched network. The compression/decompression instruction code converts between the digital audio data exchanged with the first FXS port and compressed digital audio frames exchanged with a remote telephony device over the frame switched network.

The compression/decompression instruction code and the time slot switching instruction code are mutually exclusively programmed into DSP circuits corresponding to (or serving) the first FXS port.

The media gateway may further comprise a second FXS port and a second PSTN port coupled to the TDM bus of the DSP. The second FXS port exchanges digital audio data with the DSP over the TDM bus during a third periodic time slot and the second PSTN port exchanges digital audio data with the DSP over the TDM bus during a fourth periodic time slot.

The control system further programs second time slot switching instruction code into the DSP if a media session of the second FXS port is to be connected to a destination over the PSTN. The second time slot switching instruction code: i) buffers digital audio data received from the second FXS port during an occurrence of the third periodic time slot and transfers such digital audio data to the second PSTN port during an occurrence of the fourth periodic time slot; and ii) buffers digital audio data received from the second PSTN port during an occurrence of the fourth periodic time slot and transfers such digital audio data to the second FXS port during an occurrence of the third periodic time slot.

The control system programs second compression/decompression instruction code into the DSP if a media session is to be connected to a destination over the frame switched network. The second compression/decompression instruction code converts between the digital audio data exchanged with the second FXS port and compressed digital audio frames exchanged with a remote telephony device over the frame switched network.

The second compression/decompression instruction code and the second time slot switching instruction code are mutually exclusively programmed into DSP circuits corresponding to (or serving) the second FXS port.

In a second aspect, the present invention comprises a media gateway for coupling to an Internet service provider frame switched network and coupling to a PSTN provider circuit switched network. The media gateway comprises a first FXS port to which a telephony device may be coupled to initiate a connection to a destination associated with a destination telephone number. A programmable DSP includes a TDM bus coupled to the first FXS port and a first PSTN port—coupled to a subscriber loop of the circuit switched network.

The DSP may include first compression/decompression instruction code programmed into the digital signal processor in response to determining that the connection to the destination is to be established using a real time communication channel over the frame switched network, the first compression/decompression instruction code converts between digital audio data exchanged with the first FXS port and compressed digital audio frames exchanged over the frame switched network.

Alternatively, the DSP may include first time slot switching instruction code programmed into the digital signal processor in response to determining that the connection to the destination is to be established using a circuit switched connection over the circuit switched network, the first time slot switching instruction code: i) buffers digital audio data received from the first FXS port during an occurrence of a periodic time slot assigned to the first FXS port and transfers such digital audio data to the first PSTN port during an occurrence of a periodic time slot assigned to the first PSTN port; and ii) buffers digital audio data received from the first PSTN port during an occurrence of the periodic time slot assigned to the first PSTN port and transfers such digital audio data to the first FXS port during an occurrence of the periodic time slot assigned to the first FXS port.

The first compression/decompression instruction code and the first time slot switching instruction code are mutually exclusively programmed into circuits of the digital signal processor corresponding to the first FXS port.

The media gateway may further include a control system making the determination as to whether the connection to the destination is to be established over the frame switched network or over the circuit switched network. The application determines that the connection is to be established over the circuit switched network upon determining that one of the following conditions is true: i) the media gateway is unable to communicate over the frame switched network; and ii) at least one of a delay measurement and a lost packet measurement of communication over the frame switched network has exceeded a predetermined threshold.

The media gateway may further include a second FXS port to which a telephony device may be coupled to initiate a connection to a second destination associated with a second destination telephone number. The TDM bus is further coupled to the second FXS port and a second PSTN port—coupled to a second subscriber loop of the circuit switched network.

The DSP may include second compression/decompression instruction code programmed into the DSP in response to determining that the connection to the second destination is to be established using a real time communication channel over the frame switched network. The second compression/decompression instruction code converts between digital audio data exchanged with the second FXS port and compressed digital audio frames exchanged over the frame switched network.

Alternatively, the DSP may include second time slot switching instruction code programmed into the DSP in response to determining that the connection to the second destination is to be established using a circuit switched connection over the circuit switched network. The second time slot switching instruction code: i) buffers digital audio data received from the second FXS port during an occurrence of a periodic time slot assigned to the second FXS port and transfers such digital audio data to the second PSTN port during an occurrence of a periodic time slot assigned to the second PSTN port; and ii) buffers digital audio data received from the second PSTN port during an occurrence of the periodic time slot assigned to the second PSTN port and transfers such digital audio data to the second FXS port during an occurrence of the periodic time slot assigned to the second FXS port.

The second compression/decompression instruction code and the second-time slot switching instruction code are mutually exclusively programmed into circuits of the digital signal processor corresponding to the second FXS port.

For a better understanding of the present invention, together with other and further aspects thereof, reference is made to the following description, taken in conjunction with the accompanying drawings. The scope of the present invention is set forth in the appended claims.

### BRIEF DESCRIPTION OF THE DRAWINGS

FIG. 1 is a block diagram representing a known architecture of a media gateway with PSTN backup;

FIG. 2 is a block diagramming representing a media gateway in accordance with one embodiment of the present invention;

FIG. 3 is a flow chart representing exemplary operation of a control system in accordance with one embodiment of the present invention;

FIG. 4 is a table representing an exemplary mapping of conditions to determinations in accordance with one embodiment of the present invention;

FIG. 5 is a table representing an exemplary core instruction code library in accordance with one embodiment of the present invention; and

FIG. 6 is a block diagram representing exemplary time slot switching in accordance with one embodiment of the present invention.

### DETAILED DESCRIPTION OF THE EXEMPLARY EMBODIMENTS

The present invention will now be described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code, or a combination of a hardware circuit(s) and a processor or control block of an integrated circuit executing machine readable code. As such, the term circuit, module, server, or other equivalent description of an element as used throughout this specification is intended to encompass a hardware circuit (whether discrete elements or an integrated circuit block), a processor or control block executing code, or a combination of a hardware circuit(s) and a processor and/or control block executing code.

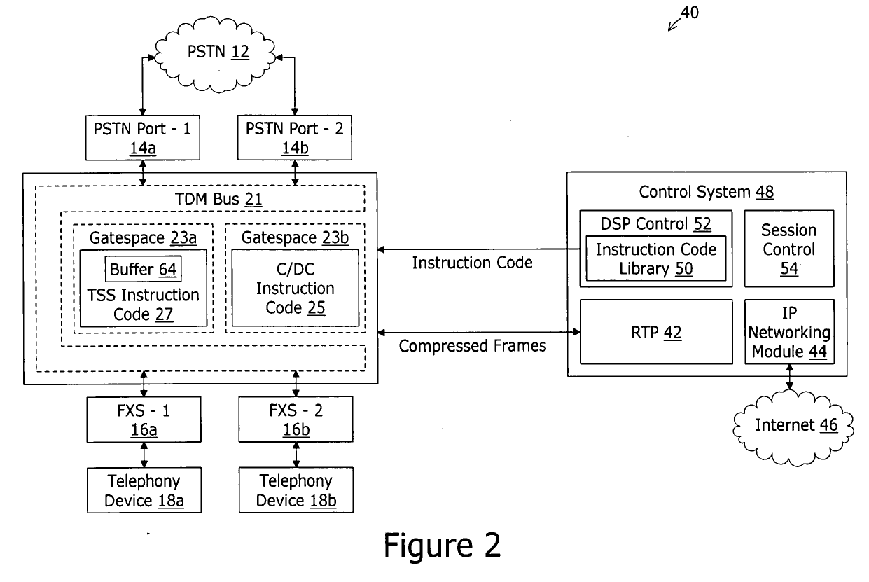

FIG. 2 represents a block diagram of an Internet media gateway 40 in accordance with one embodiment of the present invention. The Internet media gateway 40 may be embodied in a device commonly known as a multimedia terminal adapter (MTA). The Internet media gateway 40 couples to both an Internet service provider (ISP) frame switched network (e.g. Internet 46) and to a PSTN service provider circuit switched network (e.g. PSTN 12).

The Internet media gateway 40 comprises a first FXS port 16a and a second FXS port 16b. Each FXS port 16a and 16b emulates an analog or digital PSTN central office switch for providing telephone service to a known telephony device 18a, 18b such as an FXO fax machine or an FXO telephone handset.

The Internet media gateway 40 also comprises a first PSTN port 14a and a second PSTN port 14b. The PSTN port 14a couples to a first subscriber loop of the PSTN network 12 and the PSTN port 14nb couples to a second subscriber loop of the PSTN network 12. Both subscriber loops my be supported by a digital communication protocol over a common physical medium.

The Internet media gateway 40 further comprises a control system 48 and a programmable digital signal processor 20. In general, the digital signal processor 20 comprises a time division multiplexing (TDM) bus 21 interconnecting each FXS port 16a, 16b and each PSTN port 14a, 14b. Programmable circuits or gate space 23a and 23b within the DSP 20 executes instruction code provided by the control system 48 for: i) interfacing between audio samples exchanged with an FXS port corresponding to the gate space (for example, programmable gate space 23a corresponds to FXS port 16a and programmable gate space 23b corresponds to FXS port 16b) and compressed digital audio frames exchanged with the control system 48 for providing Internet telephony services to the telephony device coupled to the FXS port; and ii) routing and time switching audio samples between the corresponding FXS port and a selected PSTN port for providing PSTN telephony services to the telephony device coupled to the PSTN port.

In operation, the control system 48: i) determines whether Internet telephony services or PSTN telephony services are to be provided to a particular FXS port 16a, 16b (and its corresponding telephony device 18a, 18b); and ii) selectively programs either compression/decompression (C/DC) instruction code 25 or time slot switching instruction code 27 into the gate space 23a or 23b corresponding to the particular FXS port 16a or 16b for providing the applicable service.

To provide Internet telephony service, the C/DC instruction code 25 (loaded into gate space 23a for example): i) compresses audio samples received from the FXS port 16a (over the TDM bus 21 within an occurrence of a periodic time slot assigned to the FXS port 16a) into digital audio frames using a C/DC protocol negotiated with a remote Internet telephony endpoint; and ii) decompresses digital audio frames received from the remote Internet telephony endpoint using the negotiated C/DC protocol and delivers the decompressed audio data to the FXS port 16a over the TDM bus during an occurrence of the periodic time slot assigned to the FXS port 16a.

To provide PSTN telephony service, the switching instruction code 27 (loaded into gate space 23b for example): i) receive audio samples from the FXS port 16b over the TDM bus 21 within an occurrence of a periodic time slot assigned to FXS port 16b, buffers each such audio sample within buffer 64, and relay each such audio sample to a selected PSTN port (for example PSTN port 14b) over the TDM bus 21 within an occurrence of a periodic time slot assigned to PSTN port 14b; and ii) receives audio samples from PSTN port 14b over the TDM bus 21 within an occurrence of the periodic time slot assigned to PSTN port 14b, buffers each such sample within buffer 64, and relays each such audio sample to the FXS port 16b over the TDM bus 21 within an occurrence of the periodic time slot assigned to the FXS port 16b.

The control system 48 loads the applicable selection of either the C/DC instruction code 25 or the time slot switching instruction code 27 into gate space 23a, which corresponds to FXS port 16a, in response to determining whether a media session supported by the FXS port 16a is to be completed using a real time protocol channel over the frame switched network 46 or a circuit switched connection over the PSTN 12.

The control system 48 loads the applicable selection of either the C/DC instruction code 25 or the time slot switching instruction code 27 into gate space 23b, which corresponds to FXS port 16b, in response to determining whether a media session supported by the FXS port 16b is to be completed using a real time protocol channel over the frame switched network 46 or a circuit switched connection over the PSTN 12.

The control system 48 comprises an IP networking module 44, a session control module 54, a real time protocol (RTP) module, and a DSP control module 52. Each such module may be implemented in any combination of software, firmware, and/or hardware.

The IP networking module 44 couples the Internet media gateway 40 to an IP compliant local area network or Internet service provider (ISP) network (the Internet 46). The IP networking module 44 utilizes known IP networking and physical layer protocols which are compliant with those of the network to which the Internet media gateway 40 is coupled.

The IP networking module 44: i) formats application level data packets into TCP/IP or UDP/IP frames for transmission to remote application level systems of other network devices such as an Internet telephony service provider's infrastructure servers (not shown) and remote Internet telephony endpoints (not shown); and ii) receives TCP/IP or UDP/IP frames from other network devices and delivers the payload of each frame to the applicable application level system.

An exemplary session control module 54 may an application level system (such as an MGCP gateway application) which interfaces with the IP networking module 44 to exchange messages with the Internet telephony service provider's infrastructure and the remote Internet telephony endpoints for setting up and tearing down RTP media sessions between the RTP module 42 and a remote Internet telephony endpoint.

Setting up an RTP media session with a remote endpoint may include: i) communicating with the service provider infrastructure systems to locate and signal a media session with a remote destination endpoint; and ii) communicating with the remote endpoint to negotiate use of one of a plurality of C/DC protocols and configuration parameter for use with the protocol (such as framing size).

The RTP module 42 may be an application level module which interfaces with the IP networking module 44 to exchange real time protocol (RTP) frames representing real time audio or video media session with a remote device using UDP/IP channels over the frame switched network 46.

The RTP module 42 operates during a media session to: i) encapsulate compressed digital audio media generated by the DSP 20 into RTP frames for transmission to a remote endpoint; and ii) receives and sequences RTP frames received from the remote endpoint and presents the compressed digital media encapsulated therein to the DSP 20.

The DSP control system 52 programs either C/DC instruction code 25 or time slot switching instruction code 27 into applicable gateway space 23a,23b of the DSP 20 to selectively provide either Internet telephony service or PSTN telephony service to each of the FXS ports 16a and 16b—and its corresponding PSTN device 18a and 18b.

In the event that a telephony session is being established to support an incoming call, the selection of either C/DC instruction code 25 or time slot switching code 27 for programming into the applicable gate space 23a or 23b is based on whether the incoming call is being signaled over the PSTN 12 or signaled over the Internet 46. If the incoming call is being signaled over the PSTN 12, the DSP control system 52 programs time slot switching instruction code 27 such that the DSP interfaces between the PSTN port 14a or 14b on which the signaling is received and the selected FXS port 16a or 16b to support a PSTN telephone call. Similarly, if the incoming call is being signaled over the Internet 46, the DSP control system 52 programs C/DC instruction code 25 (corresponding to the negotiated C/DC protocol and configuration parameters) such that the DSP 20 interfaces between digital audio frames exchanged over the Internet 46 and audio samples exchanged with the FXS port 16a or 16b.

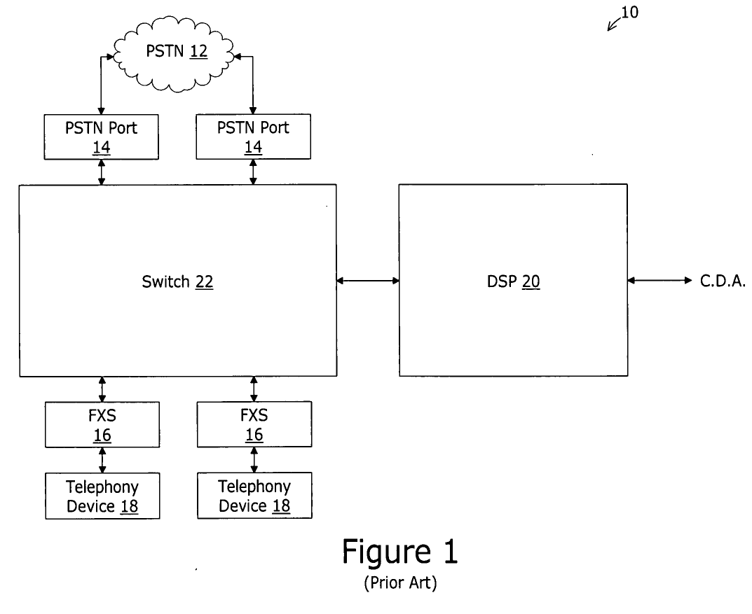

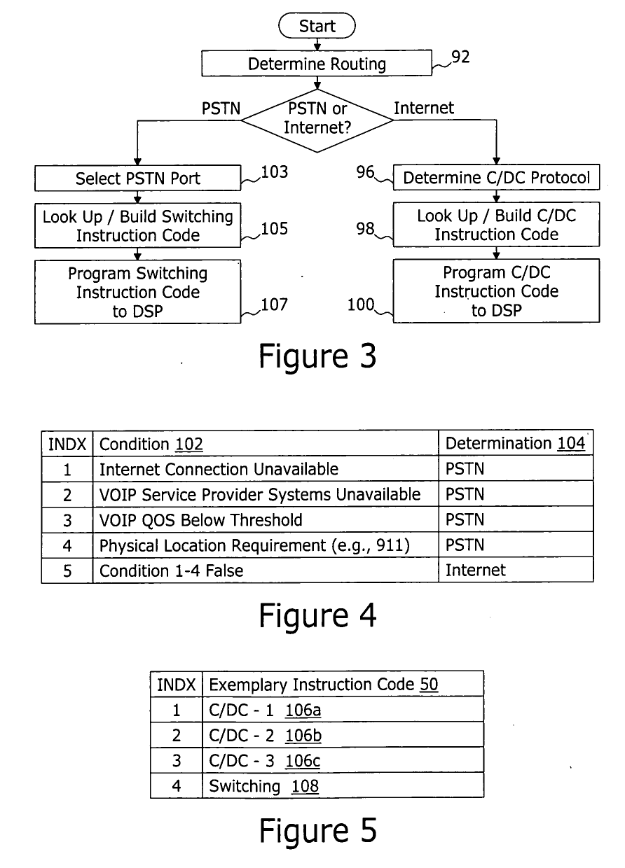

The flow chart of FIG. 3 represents exemplary operation of the control system 48 upon a telephony device 18a or 18b initiating a connection to a destination associated with a destination telephone number. Such initiation may include the DSP 20 providing an indication of the telephone number dialed using the telephony device 18a or 18b (FIG. 1).

Referring to FIG. 3 in conjunction with FIG. 1, step 92 represents determining whether to route the call to the destination associated with the dialed telephone using a real time communication channel over the frame switched network 46 or using a circuit switched connection over the circuit switched network 12.

Turning briefly to the table of FIG. 4, exemplary conditions 102 which are useful for making such a determination are represented. For example, if a connection to the Internet 46 is unavailable (Condition 1), the call should be routed to the destination using a circuit switched connection over the circuit switched network 12.

Further, even if a connection to the Internet 46 is available, the call may still be routed using a circuit switched connection over the circuit switched network 12 if: i) the VoIP service provider's infrastructure systems (such as the service providers MGCP servers) are unavailable (Condition 2); or ii) a VoIP quality of service measurement falls below threshold (Condition 3)—for example if a frame loss measurement exceeds a predetermined threshold or a frame delay measurement exceeds a predetermined threshold.

Further yet, if the destination associated with the dialed telephone number is an emergency call center—such as a 911 call center (Condition 4), the call may be routed using the circuit switched network 12 such that the call center systems can map the incoming call to the physical address of the subscriber loop.

If conditions 1 through 4 are all false (Condition 5), the call may be routed over the frame switched network 46.

Returning to FIG. 3 in conjunction with FIG. 1, if routing is over the frame switched network 46, a C/DC protocol is determined at step 96. As part of the signaling process, a C/DC protocol and configuration parameters such as frame size may be negotiated with the remote endpoint. Exemplary C/DC protocols include: i) algorithms that provide minimal (or no) compression (useful for fax transmission) such as algorithms commonly referred to as G.711, G.726; ii) very high compression algorithms such as algorithms commonly referred to as G.723.1 and G.729D; and iii) algorithms that provide compression and high audio quality such as algorithms commonly referred to as G.728, and G. 729E.

Step 98 represents looking-up and/or building the C/DC instruction code 25 for performing compression and decompression in accordance with the determined C/DC protocol and its configuration parameters. At least a portion of the instructions which comprise the C/DC instruction code 25 are stored in an instruction code library 50.

Turning briefly to FIG. 5, an exemplary instruction code library 50 is shown in table format. The instruction code library 50 comprises: i) a plurality of C/DC core code blocks 106a through 106c, each for performing one of the plurality of C/DC protocols; and ii) and a time slot switching core code block for performing time slot switching.

Each C/DC core code block 106a through 106c includes instructions for performing the compression and decompression of data. Building the C/DC instruction code 25 from a C/DC core code block 106 may include combining the core code block 106 with negotiated configuration parameter and/or parameters related to the particular FXS port 16 being supported and the periodic time slot of the TDM bus 21 assigned to the particular FXS port 16. For example, portions of the instructions relating to the periodic time slot assigned to the FXS port 16 will be built or configured to correspond to the particular FXS port 16 being used by the telephony device 18. Portions of the instructions related to framing size may be configured based on negotiated frame size.

Returning to FIG. 3, step 100 represents programming the C/DC instruction code 25 into gate space 23 of the DSP 20 corresponding to the particular FXS port 16a, 16b such that the DSP 20 can begin interfacing between digital audio samples exchanged with the FXS port 16 and compressed digital audio frames for exchange with the remote telephony endpoint over the frame switched network 46.

If at step 92 routing is determined to be over the PSTN 12, a one of the plurality of PSTN ports 14 is selected to support the connection at step 103.

Step 105 represents looking-up and/or building the time slot switching instruction code 27. At least a portion of the instructions which comprise the time slot switching instruction code 27 are stored as a time slot switching core code block 108 in the instruction code library 50 (FIG. 5).

The time slot switching core code block 108 includes instructions for performing the time slot switching of digital audio samples. Building the time slot switching instruction code 27 from the time slot switching core code block 108 may include combining the core code block 108 with parameters related to the particular FXS port 16 being supported, the particular PSTN port 14 being supported, the periodic time slot of the TDM bus 21 assigned to the particular FXS port 16, and the periodic time slot of the TDM bus 21 assigned to the particular PSTN port 14.

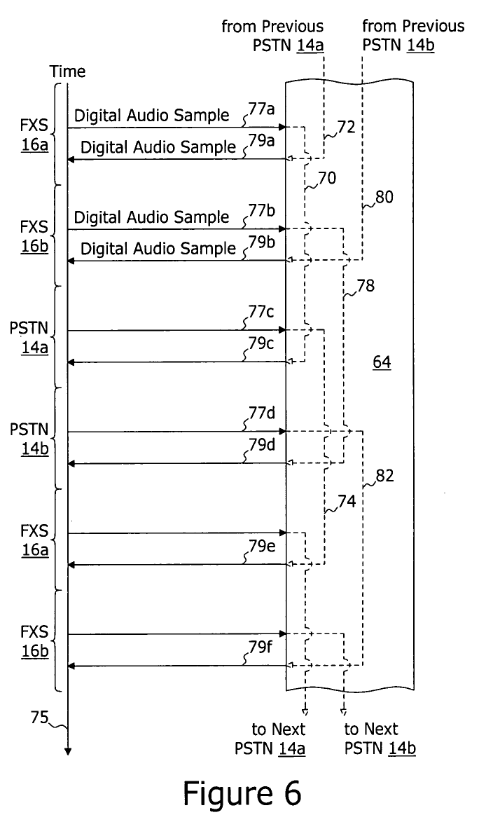

Turning to the ladder diagram of FIG. 6, exemplary operation of the time slot switching instruction code 27 is shown. More specifically, the ladder diagram of FIG. 6 represents operation of first time slot switching instruction code 27 programmed into both gate space 23a and gate space 23b for interfacing digital audio samples between: i) FXS port 16a and PSTN port 14a; and ii) FXS port 16b and PSTN port 14b.

The vertical axis 75 represents time and the various periodic time slots of the TDM bus 21 assigned to each FXS port 16a and 16b and each PSTN port 14a and 14b. During each occurrence of each periodic time slot a digital audio sample is sent over the TDM bus 21 from the FXS port 16 or the PSTN port 14 to the time slot switching instruction code 27 for buffering in buffer 64. Sending such digital audio sample in occurrence of a periodic time slot assigned to FXS port 16a is represented by arrows 77a. Arrows 77b though 77d also represent one of an FXS port 16a or 16b or PSTN port 14a or 14b sending an audio sample during an occurrence of a periodic time slot associated with such port.

Also during each occurrence of a periodic time slot, a digital audio sample is sent over the TDM bus 21 from the buffer 64 to the particular FXS port 16a or 16b or PSTN port 14a or 14b to which the periodic time slot is assigned. Sending such digital audio sample is represented by ladder arrows 79a through 79f. The TDM bus 21 is a full duplex bus.

Operation of the time slot switching is represented by block 64. The digital audio sample received from FXS port 16a during an occurrence of the periodic time slot of the TDM bus 21 assigned to FXS port 16a is buffered and subsequently delivered to PSTN port 14a during the next subsequent occurrence of the periodic time slot of the TDM bus 21 assigned to PSTN port 14a. Receipt of the audio sample is represented by arrows 77a, buffering is represented by path 70, and delivery is represented by arrow 79c.

Also during the occurrence of the periodic time slot of the TDM bus 21 assigned to FXS port 16a, a digital audio sample previously received from the PSTN port 14a (and buffered as represented by path 72) is delivered to the FXS port 16a—as represented by arrow 79a.

Also during the occurrence of the periodic time slot of the TDM bus 21 assigned to the PSTN port 14a, a digital audio sample is received from PSTN port 14a (represented by arrow 77c) is buffered (represented by arrow 74) and subsequently delivered to FXS port 16a during the next time slot of the TDM bus 21 assigned to FXS port 16a (represented by arrow 79e).

The digital audio sample received from FXS port 16b during an occurrence of the periodic time slot of the TDM bus 21 assigned to FXS port 16b is buffered and subsequently delivered to PSTN port 14b during an occurrence of the periodic time slot of the TDM bus 21 assigned to PSTN port 14b. Receipt of the audio sample is represented by arrows 77b, buffering is represented by path 78, and delivery is represented by arrow 79d.

Also during the occurrence of the periodic time slot of the TDM bus 21 assigned to FXS port 16b, a digital audio sample previously received from the PSTN port 14b (and buffered as represented by path 80) is delivered to the FXS port 16b—as represented by arrow 79b.

Also during occurrence of the periodic time slot of the TDM bus 21 assigned to the PSTN port 14b, a digital audio sample is received from PSTN port 14b (represented by arrow 77d) is buffered (represented by arrow 78) and subsequently delivered to FXS port 16b during the next occurrence of the periodic time slot of the TDM bus 21 assigned to FXS port 16b (represented by arrow 79f).

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. A media gateway for coupling to an Internet service provider frame switched network and including a secondary PSTN connection for coupling to a PSTN provider circuit switched network, the media gateway comprising:
a programmable digital signal processor;
a first FXS port coupled to the programmable digital signal processor and configured to exchange digital audio data with the digital signal processor during a first periodic time slot;
a first PSTN port coupled to the programmable digital signal processor and configured to exchange data with the digital signal processor during a second periodic time slot;
a control system programming into the digital signal processor:
first time slot switching instruction code for: i) buffering digital audio data received from the first FXS port during an occurrence of the first periodic time slot and transferring such digital audio data to the first PSTN port during an occurrence of the second periodic time slot; and ii) buffering digital audio data received from the first PSTN port during an occurrence of the second periodic time slot and transferring such digital audio data to the first FXS port during an occurrence of the first periodic time slot.

2. The media gateway of claim 1, wherein the control system further selectively programs into the digital signal processor, in replacement of the first time slot switching instruction code, compression/decompression instruction code for converting between the digital audio data exchanged with the first FXS port and compressed digital audio frames exchanged with a remote telephony device over a frame switched network.

3. The media gateway of claim 2, wherein each of the first periodic time slot and the second periodic time slot periodically occur during mutually exclusive periods of time and are of equal duration of time.

4. The media gateway of claim 1:
further comprising:
a second FXS port coupled to the programmable digital signal processor and configured to exchange digital audio data with the digital signal processor during a third periodic time slot;
a second PSTN port coupled to the programmable digital signal processor and configured to exchange data with the digital signal processor during a fourth periodic time slot;
the control system programming further programs into the digital signal processor:
second time slot switching instruction code for: i) buffering digital audio data received from the second FXS port during an occurrence of the third periodic time slot and transferring such digital audio data to the second PSTN port during an occurrence of the fourth periodic time slot; and ii) buffering digital audio data received from the second PSTN port during an occurrence of the fourth periodic time slot and transferring such digital audio data to the second FXS port during an occurrence of the third periodic time slot.

5. The media gateway of claim 4, wherein the control system further selectively programs into the digital signal processor, in replacement of at least one of the first time slot switching instruction code and the second time slot switching instruction code, compression/decompression instruction code for converting between the digital audio data exchanged with a one of the first FXS port and the second FXS port and compressed digital audio frames exchanged with a remote telephony device over a frame switched network.

6. The media gateway of claim 5, wherein each of the first periodic time slot, the second periodic time period, the third periodic time slot, and the fourth periodic time slot periodically occur during mutually exclusive periods of time and are of equal duration of time.

7. A media gateway for coupling to an Internet service provider frame switched network and including a secondary PSTN connection for coupling to a PSTN provider circuit switched network, the media gateway comprising;
a first FXS port to which a telephony device may be coupled to initiate a connection to a destination associated with a destination telephone number;
a programmable digital signal processor including:
a time-division multiplexing bus coupled to the first FXS port and a first PSTN port coupled to a subscriber loop of the circuit switched network;
first compression/decompression instruction code programmed into the digital signal processor in response to determining that the connection to the destination is to be established using a real time communication channel over the frame switched network, the first compression/decompression instruction code converting between the digital audio data exchanged with the first FXS port and compressed digital audio frames exchanged over the frame switched network; and
first time slot switching instruction code programmed into the digital signal processor in response to determining that the connection to the destination is to be established using a circuit switched connection over the circuit switched network, the first time slot switching instruction code for: i) buffering digital audio data received from the first FXS port during an occurrence of a periodic time slot associated with the first FXS port and transferring such digital audio data to the first PSTN port during an occurrence of a periodic time slot assigned to the first PSTN port; and ii) buffering digital audio data received from the first PSTN port during an occurrence of the periodic time slot assigned to the first PSTN port and transferring such digital audio data to the first FXS port during an occurrence of the periodic time slot assigned to the first FXS port.

8. The media gateway of claim 7, further comprising:
a control system making the determination as to whether the connection to the destination is to be established over the frame switched network or over the circuit switched network, the application determining that the connection is to be established over the circuit switched network upon determining that one of the following conditions is true: i) the media gateway is unable to communicate over the frame switched network; and ii) at least one of a delay measurement and a lost packet measurement of communication over the frame switched network has exceeded a predetermined threshold.

9. The media gateway of claim 8, wherein the first compression/decompression instruction code and the first time slot switching instruction code are mutually exclusively programmed into circuits of the digital signal processor corresponding to the first FXS port.

10. The media gateway of claim 7:
further comprising a second FXS port to which telephony device may be coupled to initiate a connection to a second destination associated with a second destination telephone number;
the time-division multiplexing bus is further coupled to the second FXS port and a second PSTN port coupled to a second subscriber loop of the circuit switched network; and
the programmable digital signal processor further includes:
second compression/decompression instruction code programmed into the digital signal processor in response to determining that the connection to the second destination is to be established using a real time communication channel over the frame switched network, the second compression/decompression instruction code converting between the digital audio data exchanged with the second FXS port and compressed digital audio frames exchanged over the frame switched network; and
second time slot switching instruction code programmed into the digital signal processor in response to determining that the connection to the second destination is to be established using a circuit switched connection over the circuit switched network, the second time slot switching instruction code for: i) buffering digital audio data received from the second FXS port during an occurrence of a periodic time slot assigned to the second FXS port and transferring such digital audio data to the second PSTN port during an occurrence of a periodic time slot assigned to the second PSTN port; and ii) buffering digital audio data received from the second PSTN port during an occurrence of the periodic time slot assigned to the second PSTN port and transferring such digital audio data to the second FXS port during an occurrence of the periodic time slot assigned to the second FXS port.

11. The media gateway of claim 10, further comprising:
a control system making the determination as to whether the connection to the destination is to be established over the frame switched network or over the circuit switched network, the application determining that the connection is to be established over the circuit switched network upon determining that one of the following conditions is true: i) the media gateway is unable to communicate over the frame switched network; and ii) at least one of a delay measurement and a lost packet measurement of communication over the frame switched network has exceeded a predetermined threshold.

12. The media gateway of claim 11, wherein:
the first compression/decompression instruction code and the first time slot switching instruction code are mutually exclusively programmed into circuits of the digital signal processor corresponding to the first FXS port; and
the second compression/decompression instruction code and the second time slot switching instruction code are mutually exclusively programmed into circuits of the digital signal processor corresponding to the second FXS port.

13. A method of operating a media gateway to interface between a telephony device and a selected one of a real time communication channel over a frame switched network and a circuit switched connection over a circuit switched network, the method comprising:
providing a first FXS port to which the telephony device is coupled and through which the telephony device initiates a connection to a destination associated with a destination telephone number;
providing a programmable digital signal processor, the programmable digital signal processor comprising:
a time-division multiplexing bus coupled to the first FXS port and a first PSTN port coupled to a subscriber loop of the circuit switched network;
circuits corresponding to the first FXS port for executing one of first compression/decompression instruction code and first time slot switching instruction code;
programming first compression/decompression instruction code programmed into the circuits corresponding to the first FXS port if the connection to the destination is to be established using a real time communication channel over the frame switched network, the first compression/decompression instruction code converting between the digital audio data exchanged with the first FXS port and compressed digital audio frames exchanged over the frame switched network; and
programming first time slot switching instruction code into the circuits corresponding to the first FXS port if the connection to the destination is to be established using a circuit switched connection over the circuit switched network, the first time slot switching instruction code for: i) buffering digital audio data received from the first FXS port during an occurrence of a periodic time slot assigned to the first FXS port and transferring such digital audio data to the first PSTN port during an occurrence of a periodic time slot assigned to the first PSTN port; and ii) buffering digital audio data received from the first PSTN port during an occurrence of the periodic time slot assigned to the first PSTN port and transferring such digital audio data to the first FXS port during an occurrence of the periodic time slot assigned to the first FXS port.

14. The method of claim 13, further comprising:
determining whether the connection to the destination is to be established over the frame switched network or over circuit switched network in response to determining whether one of the following conditions is true: i) the media gateway is unable to communicate over the frame switched network; and ii) at least one of a delay measurement and a lost packet measurement of communication over the frame switched network has exceeded a predetermined threshold.

15. The method of claim 14, wherein the first compression/decompression instruction code and the first time slot switching instruction code are mutually exclusively programmed into the circuits of the digital signal processor corresponding to the first FXS port.

16. The media gateway of claim 13:
further comprising providing a second FXS port to which a second telephony device is coupled and through which the second telephony device initiates a connection to a second destination associated with a second destination telephone number;
the a time-division multiplexing bus is further coupled to the second FXS port and a second PSTN port coupled to a second subscriber loop of the circuit switched network; and
the method further comprises:
programming second compression/decompression instruction code programmed into circuits corresponding to the second FXS port if the connection to the second destination is to be established using a real time communication channel over the frame switched network, the second compression/decompression instruction code converting between the digital audio data exchanged with the second FXS port and compressed digital audio frames exchanged over the frame switched network; and
programming second time slot switching instruction code into the circuits corresponding to the second FXS port if the connection to the second destination is to be established using a circuit switched connection over the circuit switched network, the second time slot switching instruction code for: i) buffering digital audio data received from the second FXS port during an occurrence of a periodic time slot assigned to the second FXS port and transferring such digital audio data to the second PSTN port during an occurrence of a periodic time slot assigned to the second PSTN port; and ii) buffering digital audio data received from the second PSTN port during an occurrence of the periodic time slot associated with the second PSTN port and transferring such digital audio data to the second FXS port during an occurrence of the periodic time slot assigned to the second FXS port.

17. The method of claim 16, further comprising:
determining whether the connection to the destination is to be established over the frame switched network or over circuit switched network in response to determining whether one of the following conditions is true: i) the media gateway is unable to communicate over the frame switched network; and ii) at least one of a delay measurement and a lost packet measurement of communication over the frame switched network has exceeded a predetermined threshold.

18. The method of claim 17, wherein:
the first compression/decompression instruction code and the first time slot switching instruction code are mutually exclusively programmed into common circuits of the digital signal processor corresponding to the first FXS port; and
the second compression/decompression instruction code and the second time slot switching instruction code are mutually exclusively programmed into common circuits of the digital signal processor corresponding to the second FXS port.
